(19) United States
(12) Patent Application Publication
(10) Pub. No.: US 2013/0140805 A1
(43) Pub. Date: Jun. 6, 2013

(54) Easel Pad with Electrostatic Sheets

(71) Applicant: Michael W. Fogarty, Alexandria, VA (US)

(72) Inventor: Michael W. Fogarty, Alexandria, VA (US)

(21) Appl. No.: 13/690,222

(22) Filed: Nov. 30, 2012

Related U.S. Application Data
(60) Provisional application No. 61/566,311, filed on Dec. 2, 2011.

(51) Int. Cl. B42D 17/00

(52) U.S. Cl. CPC B42D 17/00
USPC 281/44

(57) ABSTRACT

Described herein is a method and easel pad on which an attendee at a meeting can write information such as notes, comments, figures, etc. in a way that is visible to all attendees and which can be easily retained throughout the meeting. In practice, a user brings into the meeting room an easel pad comprised of a pad of electrostatic sheets. The easel pad further comprises a starter slit on each sheet of the pad of electrostatic sheets, and a cutter blade for accommodating easy handling, cutting and removal of a sheet from the pad. The pad is placed on an easel. During the meeting or in preparation thereof, information is written on the pad of electrostatic sheets. When desired, one can tear off the top electrostatic sheet on which the information has been written, and simply apply the sheet to any surface, such as a wall or separate board, so that the sheet clings to the surface due to the electrostatic attraction. Everyone in the meeting can still view the sheet containing the written information, while new information is being discussed and written on the next electrostatic sheet of the easel pad.

### CROSS-REFERENCE TO RELATED APPLICATIONS

This application claims priority to U.S. Provisional Application No. 61/566,311 filed Dec. 2, 2011, entitled “Easel Pad with Electrostatic Sheets” the contents of which are incorporated herein by reference in their entirety.

### BACKGROUND OF THE INVENTION

This disclosure relates to methods and apparatus for enabling attendees at a meeting to write information in such a manner that it is displayed to all attendees, and later conveniently retained for future reference.

In meetings and conferences, it is common for individuals to write information such as notes, numbers, drawings, etc. on a large surface, such as an erasable drawing board, or a large easel mounted pad, so that it can be seen by all present in the room. However, not all rooms in which meetings occur are equipped with such an erasable board, and it can be inconvenient to have to find and set up such equipment.

Moreover, if it is desired to memorialize information written on an erasable board during the meeting, it is necessary to separately make a hand copy, which is inconvenient and possibly impossible if the information has already been erased from the board. Erasable writing boards are available which incorporate a copier, but they are relatively expensive and not easily transportable.

In lieu of erasable boards, easel-mounted paper pads or flip charts can be used which enable the written-on sheets to be later removed and retained. In order to view the information that was previously written during the meeting, however, constant flipping of the sheets of the pad is necessary. This is often ineffective and cumbersome.

Easel pads are available which utilize a pad of paper sheets bound by a pressure sensitive adhesive. Only one side of such paper sheets can generally be used, and more importantly the sheets are limited in the type of surface to which they will adhere.

It would be desirable to enable information to be written and displayed during a meeting such that all of the information written can be viewed easily and economically, without limitations.

### SUMMARY OF THE INVENTION

Described herein is a method and easel pad on which an attendee at a meeting can write information such as notes, comments, figures, etc. in a way that is visible to all attendees and which can be easily retained throughout the meeting. In practice, a user brings into the meeting room an easel pad comprised of a pad, e.g., stack, of electrostatic sheets. The easel pad further comprises a starter slit on each sheet of the pad of electrostatic sheets, and a cutter blade for accommodating easy handling, cutting and removal of a sheet from the pad.

The easel pad is placed on an easel. In one embodiment, the pad accommodates certain retainer prongs of the easel to better secure the pad to the easel. During the meeting or in preparation thereof, information is written on the pad of electrostatic sheets. When desired, one can tear off or rip off the top electrostatic sheet on which the information has been written, and simply apply the sheet to any surface, such as a wall or separate board, so that the sheet clings to the surface due to the electrostatic attraction. The removal of the electrostatic sheet from the pad is facilitated by a starter slit in the sheet, and the cutter blade on the pad. Everyone in the meeting can still view the sheet containing the written information, while new information is being discussed and written on the next electrostatic sheet of the easel pad.

Among other factors, it has been found that the easel pad facilitates discussion during a meeting by allowing one to easily remove an electrostatic sheet with written information on it and applying the sheet to a nearby wall or board, e.g., any vertical or horizontal surface including rounded columns, ceilings, or walls. Reference to the written information is thus easily made as the discussion continues and new information is written on the next sheet. Many such sheets can be applied to the wall or board, allowing all of the written information to be easily viewed during the entire meeting. Furthermore, the starter slit for each electrostatic sheet and the cutter blade on the easel pad permit easy handling and removal of the electrostatic sheets for uninterrupted discussion.

### BRIEF DESCRIPTION OF THE FIGURES OF THE DRAWING

FIG. 1 is a perspective view of an easel pad of the present invention, containing the pad of electrostatic sheets.

FIG. 2 is a view of the subject easel pad on an easel.

FIG. 3 is a view of the subject easel pad on an easel with an electrostatic sheet from the easel pad applied to a nearby vertical surface.

### DETAILED DESCRIPTION OF THE INVENTION

The easel pad comprises a pad, i.e., a stack or layers of sheets, of conventional electrostatic or electret film/paper. The pad of electrostatic film sheets can contain any number of sheets. The electrostatic sheets can cling to almost any surface, unlike pressure sensitive adhesive products. Therefore, the use of the electrostatic sheets offers many advantages and is nearly devoid of limitation.

The sheets are stacked and combined as a pad of sheets. Each sheet, however, has a starter slit to facilitate tearing of the sheet from the pad. The easel pad also comprises a cutter blade, which can be a conventional serrated metal strip that further facilitates an easy, clear removal of a sheet from the pad of sheets on the easel pad.

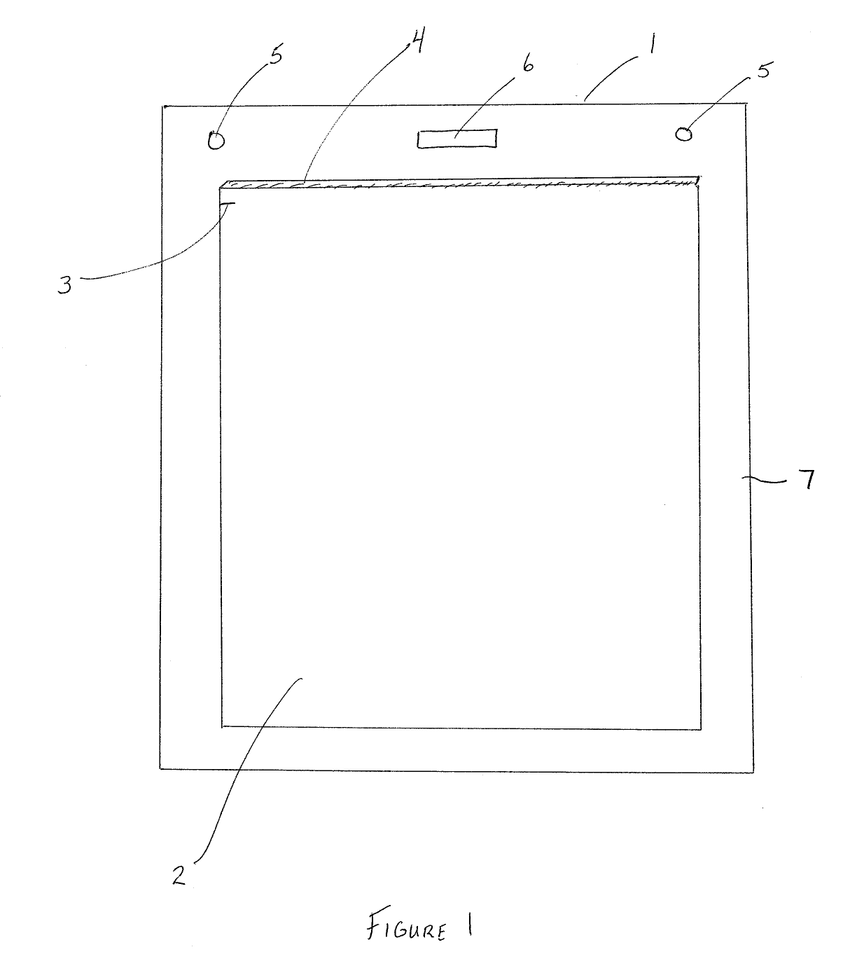

A preferred pad is shown in FIG. 1. The easel pad 1 comprises a pad, e.g., stack of electrostatic sheets 2, with each sheet of the pad having a starter slit 3 to facilitate the beginning of the sheet being torn off of the pad 1. A cutter blade 4 is also on the easel pad, and is positioned to further facilitate a clean and easy removal of the sheet from the pad of electrostatic sheets 2. A backer board 7 can also be used as part of the easel pad 1, which gives further support to the pad of electrostatic sheets 2. The cutter blade 4 is generally located at the top of the pad of electrostatic sheets, and can be directly above the pad of electrostatic sheets, but need not actually be part of the pad of sheets. The cuter blade can be part of the pad of sheets, or part of the backer 7. The cutter blade can be in the form of a conventional serrated metal strip, or a slide-type of cutter. The cutter blade, in conjunction with the starter slit, allows for an easy removal of a sheet from the easel pad.

The pad of individual electrostatic sheets 2 can comprise conventional electrostatic or electret film/paper sheets. The sheets can be written on with conventional writing tools, such as magic markers, crayons and dry erase markers. All colors of magic marker, or of any writing instrument, can be used. Permanent markers such as magic markers can be used when a permanent record is desired. Erasable markers, such as dry erase markers, can be used when eventual erasure is desired.

The pad can also have openings to accommodate retainer prongs or security prongs of the easel on which the easel pad is placed. In FIG. 1, these openings are shown at 5 and 6. Opening 6 can also serve as a handle for safely and easily carrying the easel pad. The opening can accordingly be die cut to better serve such a purpose.

The openings can be designed to fit with the prongs of a particular easel, in both size and shape. The meshing of the openings with the easel allows for secure placement of the pad, with little movement when writing. This allows for better writing of information on the pad of electrostatic sheets during the presentation and discussion in the meeting.

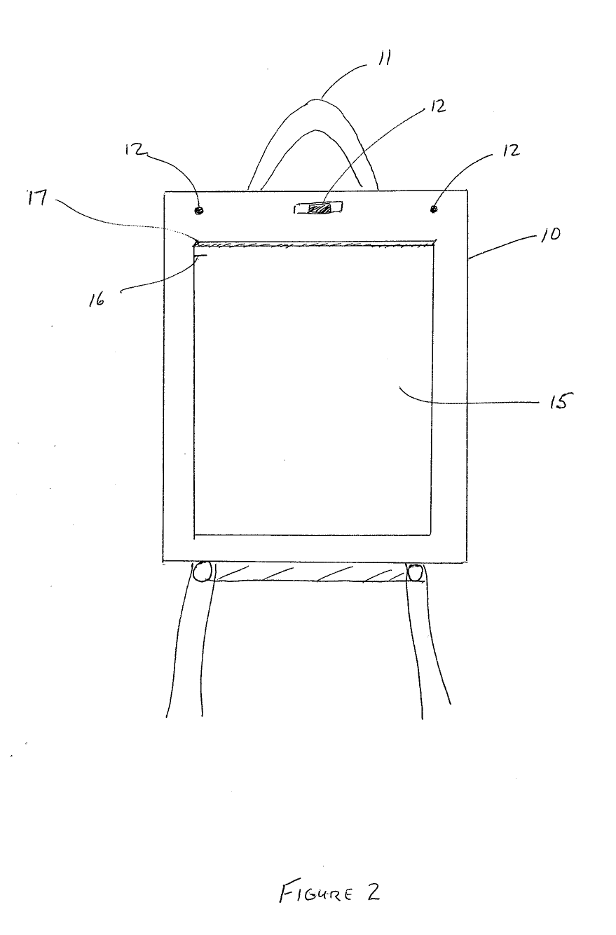

FIG. 2 shows the subject easel pad 10 secured on an easel 11. Openings 12 within the easel pad 10 have prongs from the easel fitting through them to secure the easel pad to the easel. The pad of electrostatic film sheets 15 is part of the easel pad 10, with each sheet having a starter slit 16. A cutter blade 17 is also part of the pad of electrostatic film sheets 15.

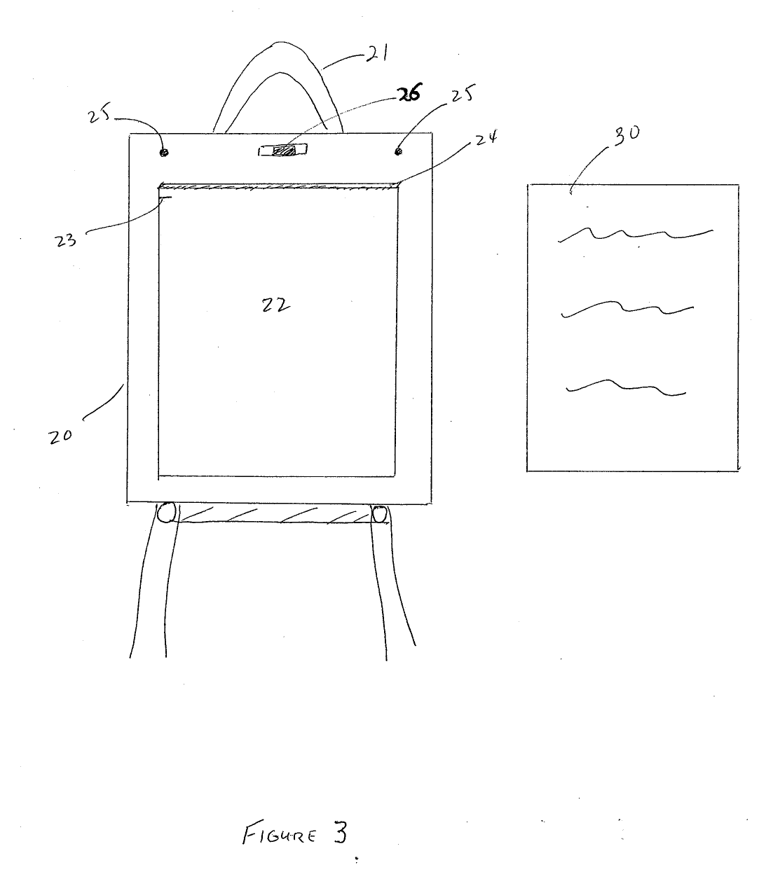

Referring to FIG. 3, in practice, an easel pad 20 is placed on an easel 21 in a meeting room. The pad comprises a pad of electrostatic sheets 22, with each sheet having a starter slit 23 in its upper portion to facilitate the beginning of removal of a sheet. The easel pad also comprises a cutter blade 24 to facilitate complete removal of the electrostatic sheets. The easel pad can be secured to the easel by prongs of the easel fitting into openings 25 and 26. The middle opening 26 can also serve as a handle for easily carrying the easel pad 20.

If it becomes desirable during the meeting to write information in such a manner that it is displayed to all attendees, one can write on the electrostatic sheets of the easel pad using one or more writing tools, of any color. When it is desired to write information on a second sheet, the first sheet can be removed easily from the easel pad due to the starter slit 23 and cutter blade 24, with the sheet 30 applied to a vertical surface, e.g., nearby wall or board. The sheet 30 clings to the wall or separate board due to its electrostatic attraction. Thus, as more information is written on sheet 22, the information previously written on sheet 30 can still be viewed by the attendees at the meeting. As many sheets as desired can be torn/removed from the pad of electrostatic sheets 22 and applied to a vertical surface as sheet 30.

It will be appreciated that the above-described method and easel pad provide an economical and convenient way of enabling information to be displayed at a meeting and thereafter retained throughout the meeting. Use of the easel pad facilitates continuous and effective discussion, as the pad with its features accommodates such discussion without cumbersome interruption.

All patents and publications referenced herein are hereby incorporated by reference to the extent not inconsistent herewith. It will be understood that certain of the above-described structures, functions, and operations of the above-described embodiments are not necessary to practice the present invention and are included in the description simply for completeness of an exemplary embodiment or embodiments. In addition, it will be understood that specific structures, functions, and operations set forth in the above-described referenced patents and publications can be practiced in conjunction with the present invention, but they are not essential to its practice. It is therefore to be understood that the invention may be practiced otherwise than as specifically described without actually departing from the spirit and scope of the present invention as defined by the appended claims.

What is claimed is:

1. An easel pad comprising a stacked pad of electrostatic sheets, each sheet having a starting slit in its upper portion for removal from the stacked pad, and a cutter blade for cutting the electrostatic sheets and facilitating removal from the easel pad.

2. The easel pad of claim 1, wherein the easel pad has holes to accommodate holding prongs of an easel.

3. A method of using the easel pad of claim 1, comprising setting up the easel pad on an easel in a meeting room, writing information on a top sheet of the stacked pad of electrostatic sheets, tearing the sheet on which the information was written and removing it from the easel pad, and applying the removed sheet on which the information was written to a vertical surface.

4. The method of claim 3, wherein information is then written on a next top sheet of the stacked pad of electrostatic sheets.
